(19) United States
(12) Patent Application Publication
(10) Pub. No.: US 2024/0051886 A1
(43) Pub. Date: Feb. 15, 2024

(54) MANUFACTURING A COMPOSITE FERTILISER PELLET

(71) Applicant: Anglo American Woodsmith Limited, Greater London (GB)

(72) Inventor: Timothy David Lewis, York (GB)

(21) Appl. No.: 18/269,418

(22) PCT Filed: Dec. 23, 2021
(86) PCT No.: PCT/GB2021/053423

§ 371 Date: Jun. 23, 2023

(30) Foreign Application Priority Data
Dec. 23, 2020 (GB) 2020552.2

(51) Int. Cl. C05B 19/00

(52) U.S. Cl. CPC C05B 19/00

(57) ABSTRACT

A method for forming a pelletised fertiliser product, the method comprising: forming a first mixture of phosphoric acid and ammonia; adding the first mixture and polyhalite powder to a granulator to form a second mixture; and supplying ammonia to the second mixture to complete formation of ammonium phosphate within the second mixture whilst the granulator is processing the second mixture to form pellets.

This invention relates to a method for forming a fertiliser pellet and a fertiliser pellet.

A common way to supplement the nutrients that are available to plants is to treat a seedbed, field or other growing medium with fertiliser products in the form of agglomerated pellets. Pelletised products can have the advantages of being stable, easy to spread using convention horticultural or agricultural machinery, and readily dispensed at a desired application rate.

A wide range of fertiliser compositions are available. The effectiveness of a particular fertiliser composition depends on factors including the type of plants for which it is used, the state of maturity of the plants, the existing state of the growing medium, and the environmental conditions.

Key plant nutrients include nitrogen, phosphorus, potassium, magnesium, calcium and sulphur. In a fertiliser composition these individual nutrient elements may be incorporated through their inclusion in any of a number of chemical compounds. Although different compounds may include the same underlying nutrient element the bioavailability of those nutrient elements may differ depending on the mechanism by which the compound breaks down. The nutrients' bioavailability may also vary as a result of other aspects of the fertiliser's chemical or mechanical formulation. For example, some fertiliser pellets may incorporate coatings or binders that break down slowly in order to delay the release of nutrients, some compounds may rely on microbiota in the growing medium in order to release their nutrient elements and some compositions may make nutrients available in a chelated form so as to improve their uptake.

In order to provide multiple nutrients a grower may apply multiple distinct fertiliser compositions or alternatively a single multi-nutrient fertiliser composition. In order for a multi-nutrient composition to be effective its constituent compounds must be in suitably balanced proportions and must be capable of acting effectively even in the presence of the other constituents. This effectiveness may rely on factors other than the contents of the fertiliser: for example the presence of environmental water, heat or certain microbiota. The effectiveness on plants of multiple-nutrient fertilisers, particularly when dependent on environmental factors, is difficult to predict. However, if a multi-nutrient fertiliser composition is effective then it has the advantage that it requires only a single spreading operation to apply it to a crop.

Certain minerals, particularly evaporite minerals, can be used as sources of nutrients such as potassium, calcium, magnesium and sulphur. For example, Gypsum can be pelletised and used as a source of calcium and sulphur.

Polyhalite is an evaporite mineral. It is a complex hydrated sulphate of potassium, calcium and magnesium of general formula K₂Ca₂Mg(SO₄)₄·2H₂O. Deposits of polyhalite occur in, amongst other countries, Austria, China, Germany, India, Iran, Turkey, Ukraine, the UK and the USA.

Polyhalite has the capacity to be valuable as a source of agricultural fertiliser. In some prior art processes it has been proposed to decompose natural polyhalite to extract specific nutrients. See, for example, WO 2013/074328, U.S. Pat. Nos. 1,946,068 and 4,246,019. However, intact polyhalite is also usable as a fertiliser, being able to supply sulphur, potassium, calcium and magnesium to the soil.

Mineral polyhalite can be spread in raw, crushed form. That minimises processing costs, but it has a number of disadvantages. Once applied to the soil the raw mineral takes some time to break down, delaying the bioavailability of its constituents. If applied in chipped form, the polyhalite tends to be of irregular shape and size, meaning that there can be difficulties in applying it uniformly, and meaning that it can be difficult to apply using some types of agricultural spreading machinery. Powdered polyhalite is difficult to spread evenly in an agricultural application, and since polyhalite powder can be hygroscopic its mechanical properties can vary quickly and radically over time once exposed to air.

It would be desirable to have a fertiliser product which is readily spread and provides a number of nutrients in a manner that is particularly beneficial to plants.

According to a first aspect of the present invention there is provided a method for forming a pelletised fertiliser product, the method comprising: forming a first mixture of phosphoric acid and ammonia; adding the first mixture and polyhalite powder to a granulator to form a second mixture; and supplying ammonia to the second mixture to complete formation of ammonium phosphate within the second mixture whilst the granulator is processing the second mixture to form pellets.

The granulator may process the second mixture to form pellets by mixing the second mixture whilst ammonia is supplied. Forming a first mixture of phosphoric acid and ammonia may comprise mixing the phosphoric acid whilst introducing ammonia to the phosphoric acid. The ammonia present in the first mixture may react with the phosphoric acid to form ammonium phosphate, and the ammonia may be introduced in an amount that is insufficient to complete formation of ammonium phosphate within the first mixture. Supplying ammonia to the second mixture may comprise introducing ammonia gas to the second mixture. Supplying ammonia to the second mixture may comprise introducing liquid ammonia to the second mixture. The ammonia present in the second mixture may react with the phosphoric acid to form ammonium phosphate, and the ammonia may be introduced in an amount that is sufficient to complete formation of ammonium phosphate within the second mixture. A predetermined ratio of ammonia to phosphoric acid may complete formation of ammonium phosphate from phosphoric acid, and an amount of ammonia may be introduced to the first mixture at less than the predetermined ratio. A predetermined ratio of ammonia to phosphoric acid may complete formation of ammonium phosphate from phosphoric acid, and the ammonia may be introduced to the second mixture to substantially meet the predetermined ratio.

Forming a first mixture of phosphoric add and ammonia may comprise adding a liquid to the first mixture. The liquid may be water. The liquid may be ammonia.

The powder may have a mass average grain size in the range from 50 to 500 μm. The pellets may comprise more than 80% by weight of the mixture of polyhalite powder and ammonium phosphate. An amount of first mixture may be added to the polyhalite powder so that the pellets comprise between 20% and 80% of ammonium phosphate by weight. An amount of first mixture may be added to the polyhalite powder so that the pellets comprise between 20% and 80% of polyhalite powder by weight.

According to a second aspect of the present invention there is provided a fertiliser pellet principally composed of a mixture of polyhalite powder and ammonium phosphate.

The pellet may comprise between 60% and 80% of ammonium phosphate by weight. The pellet may comprise between 20% and 40% of polyhalite powder by weight. The pellet may comprise more than 80% by weight of the mixture of polyhalite powder and ammonium phosphate.

According to a third aspect of the present invention there is provided a fertiliser product comprising a plurality of pellets as herein described. According to a fourth aspect of the present invention there is provided a pelletised fertiliser product wherein at least 50% of the pellets are pellets as herein described.

The present invention will now be described by way of example with reference to the accompanying drawings. In the drawings:

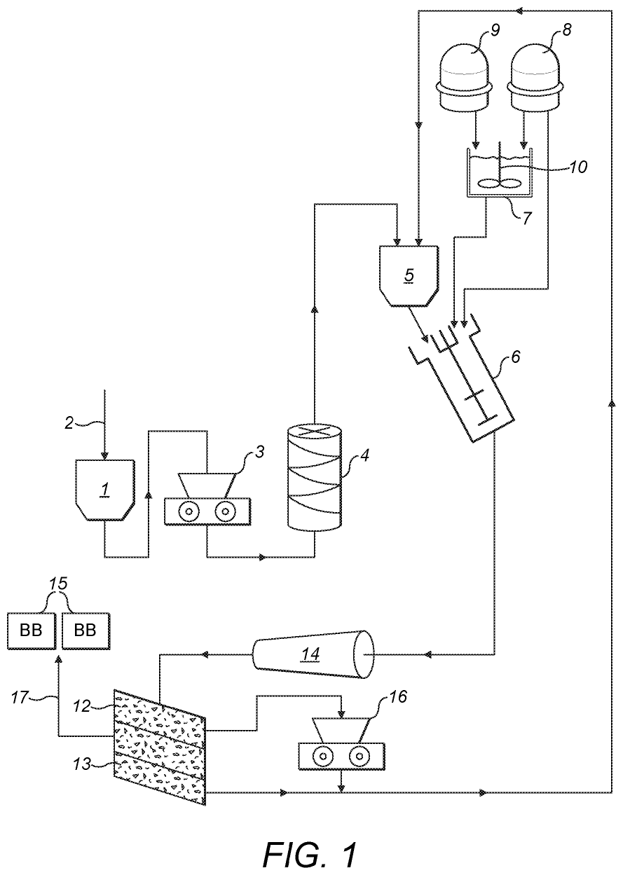

FIG. 1 shows a generalised overview of a fertiliser production process.

The following description is presented to enable any person skilled in the art to make and use the invention, and is provided in the context of a particular application. Various modifications to the disclosed embodiments will be readily apparent to those skilled in the art.

The general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The present invention relates to a method for forming a pelletised fertiliser product. The method comprises forming a first mixture of phosphoric acid and ammonia and adding the first mixture and polyhalite powder to a granulator to form a second mixture. The method further comprises supplying ammonia to the second mixture to complete formation of ammonium phosphate within the second mixture whilst the granulator is processing the second mixture to form pellets. The present invention also relates to a fertiliser pellet principally composed of a mixture of polyhalite powder and ammonium phosphate.

FIG. 1 shows a generalised overview of a fertiliser production process. The production process will be described with reference to FIG. 1.

As indicated above, polyhalite is a complex hydrated sulphate of potassium, calcium and magnesium of general formula K₂Ca₂Mg(SO₄)₄·2H₂O. Polyhalite has a Moh's hardness of around 2.5 to 3.5. Polyhalite can be extracted from natural reserves by mining. As-mined polyhalite may be intimately combined with other minerals which form impurities in the polyhalite. These other minerals are preferable in low proportions (e.g. less than 10% or less than 5% in good quality ore.) Once mined, the polyhalite may be broken into blocks or chips of suitable size for transport and processing. For example, the as-mined rock may be fed to crushers such as jaw crushers and/or cone crushers in order to yield a chipped material of generally uniform size. It has been found that chips of largest dimension no greater than around 20 mm and/or of average dimension between 5 and 10 mm are convenient for transportation from a mine. The chips can be transported by conveyor, trucks or any other convenient mechanism.

The polyhalite chips are loaded into a first hopper 1 as indicated by arrow 2. The polyhalite chips are output from the first hopper to be processed into a powder form.

The raw or chipped polyhalite is processed to form a powder essentially of polyhalite. This may suitably be done using high pressure grinding roller (HPGR) equipment 3, or in a ball mill (e.g. a continuous “Hardinge” ball mill) or an attritor mill. The average grain size of the powder is dependent on various process parameters including the dwell time of the feedstock in the powdering equipment and the configuration of the powdering equipment. Oversized particles exiting the powdering equipment may be returned to the equipment for further processing. The desired powder size will depend on the nature of the subsequent processing steps, but it has been found that screening the output of the powdering process with a 500 μm screen and accepting the material passing the screen for further processing yields good results. Oversized particles exiting the powdering equipment and not passing the screen may be returned to the powdering equipment for further processing. A convenient profile of the powder passed to the next step of the process is: 100% passing a 500 μm screen and 80% (by mass) passing a 200 μm screen. Conveniently at least 50% or more preferably at least 70% of the mass of the powder is composed of grains having a grain size, or a largest or average diameter, in the range from 50 to 500 μm, more preferably from 100 to 250 μm. The grain size may be as measured by means of a Malvern Mastersizer 3000 or as measured by means of a sieve shaker.

Impurities in the mined rock may be separated before the mined rock is powdered. Alternatively, if the impurities are in reasonably low proportion to the desired mineral then it may be retained and powdered. Thus, the powdered polyhalite may comprise other minerals too.

The powdered polyhalite is passed through an air cyclone 4. The air cyclone 4 separates the powdered polyhalite into particles that are of a desired size whilst oversized particles fall back down the air cyclone 4 to be recycled. The output from the air cyclone 4 is loaded into a second hopper 5. The second hopper 5 outputs into equipment that can both mix and pelletise. Thus, the second hopper 5 can output into a granulator 6 as shown in FIG. 1.

The granulator 6 is also supplied with liquid from a preneutraliser 7 and from a first storage tank 8. The first storage tank 8 holds liquid ammonia or ammonia gas. There may be cases where both liquid ammonia and ammonia gas is used in the process. In this case, there may be separate storage tanks for the liquid ammonia and ammonia gas. It will be understood that a reference to one of liquid ammonia or ammonia gas may involve using a proportion of each or one followed by the other. Alternatively, only one of liquid ammonia or ammonia gas may be used during the process.

A second storage tank 9 holds phosphoric acid. The first storage tank 8 and the second storage tank 9 are connected to the preneutraliser 7. The preneutraliser 7 is supplied with phosphoric acid from the second storage tank 9 and ammonia liquid/gas from the first storage tank 8. An amount of phosphoric acid may be introduced to the preneutraliser 7 and then ammonia liquid/gas supplied by a tube into the phosphoric acid so that the ammonia liquid/gas bubbles through the phosphoric acid to react with the acid. The preneutraliser 7 may comprise a mixing paddle 10 to mix the liquid present in the preneutraliser 7. The combination of phosphoric acid and ammonia liquid/gas in the preneutraliser 7 forms a first mixture of phosphoric acid and ammonia. The first mixture may be in the form of a slurry.

When the ammonia liquid/gas is introduced to the phosphoric acid the ammonia liquid/gas reacts with the phosphoric acid. This reaction causes the creation of ammonium phosphate. The introduction of the ammonia liquid/gas reduces the pH of the first mixture. The amount of ammonia liquid/gas introduced may be selected to mean that the pH of the first mixture is reduced to about 5-6. Monoammonium phosphate (MAP), diammonium phosphate (DAP) or a combination of the two may be created in the first mixture in the preneutraliser depending on the amount of ammonia liquid/gas that is introduced to the phosphoric acid. The amount of ammonia liquid/gas that is introduced to the first mixture is less than that required to complete the formation of ammonium phosphate (whether in MAP or DAP form as desired). By which it is meant that when the formation of ammonium phosphate is complete there is substantially no phosphoric acid remaining in the mixture.

There is a predetermined ratio of ammonia to phosphoric acid which completes the formation of ammonium phosphate from phosphoric acid. This predetermined ratio may be a target ratio. The predetermined ratio depends on whether MAP or DAP is being produced. The predetermined ratio for MAP is 1:1. The predetermined ratio for DAP is 2:1.

Water may also be introduced to the preneutraliser to assist in the mixing of the phosphoric acid and ammonia.

The preneutraliser 7 is connected to the granulator 6 so that the preneutraliser 7 can supply the first mixture of phosphoric acid and ammonia to the granulator 6. The first storage tank is additionally connected to the granulator 6 so that the granulator 6 can be supplied directly with ammonia liquid/gas.

An example of such a granulator equipment is an intensive mixer/granulator, e.g. as available from Maschinenfabrik Gustav Eirich GmbH & Co KG. A granulator may be configured to expel processed material as it operates, allowing it to run continuously. Alternatively, the granulator may operate on a batch basis, with material being processed according to a defined programme and then expelled en masse.

Polyhalite powder is passed to the granulator 6 from the second hopper 5. The first mixture is also passed to the granulator 6 from the preneutraliser 7. The amount of polyhalite powder and first mixture passed to the granulator 6 is selected in dependence on the desired ratio of polyhalite to ammonium phosphate in the final pellets. The addition of the polyhalite powder and first mixture forms a second mixture by virtue of it being mixed by the granulator 6.

Ammonia liquid/gas is injected into the granulator from the first storage tank 8. Ammonia liquid/gas is thus injected into the second mixture. The amount of ammonia liquid/gas that is injected is selected to complete the formation of ammonium phosphate in the second mixture. The second mixture can be tested to determine when the pH of the second mixture reaches about 7 which indicates the completion of the formation of ammonium phosphate within the second mixture. The ammonium phosphate in the second mixture may be in the form of DAP or MAP depending on the amount of ammonium introduced to the preneutraliser 7 and into the granulator 6.

The introduction of the liquid from the preneutraliser 7 also has the effect of causing the agglomeration of the polyhalite powder, and hence the agglomeration and pelletisation of the second mixture in the granulator 6.

The amount of first mixture and ammonium that is introduced to the polyhalite powder in the granulator may be selected according to the desired ratio of polyhalite powder to ammonium phosphate in the pellets. The ratio of polyhalite powder to ammonium phosphate by weight in the pellet may be generally 1:10, 1:5, 3:10, 2:5, 1:2, 3:5, 7:10, 4:5, 9:10, 1:1, 10:9, 5:4, 10:7, 5:3, 2:1, 5:2, 10:3, 5:1, 10:1.

The pellet may comprise more than 20% of polyhalite by weight, more than 30% of polyhalite by weight, more than 40% of polyhalite by weight, more than 50% of polyhalite by weight, more than 60% of polyhalite by weight, more than 70% of polyhalite by weight, more than 80% of polyhalite by weight. Preferably the fertiliser product may comprise less than 80% of polyhalite by weight, more preferably less than 60% of polyhalite by weight, more preferably between 20% and 40% of polyhalite by weight and more preferably between 20% and 35% of polyhalite by weight.

The pellet may comprise more than 20% of ammonium phosphate by weight, more than 30% of ammonium phosphate by weight, more than 40% of ammonium phosphate by weight, more than 50% of ammonium phosphate by weight, more than 60% of ammonium phosphate by weight, more than 70% of ammonium phosphate by weight, more than 80% of ammonium phosphate by weight. Preferably the fertiliser product may comprise more than 20% of ammonium phosphate by weight, more preferably more than 40% of ammonium phosphate by weight, more preferably between 60% and 80% of ammonium phosphate by weight and more preferably between 65% and 80% of ammonium phosphate by weight.

The pellet may be principally composed of a mixture of polyhalite powder and ammonium phosphate by weight. The pellet may comprise more than 80% by weight of a mixture of polyhalite powder and ammonium phosphate by weight, 85% by weight of a mixture of polyhalite powder and ammonium phosphate by weight, 90% by weight of a mixture of polyhalite powder and ammonium phosphate by weight, 95% by weight of a mixture of polyhalite powder and ammonium phosphate by weight, 96% by weight of a mixture of polyhalite powder and ammonium phosphate by weight, 97% by weight of a mixture of polyhalite powder and ammonium phosphate by weight, 98% by weight of a mixture of polyhalite powder and ammonium phosphate by weight, 99% by weight of a mixture of polyhalite powder and ammonium phosphate by weight, 99.5% by weight of a mixture of polyhalite powder and ammonium phosphate by weight.

At the completion of the pelletising process, the pellets are expelled from the granulator 6 onto drier 14 which may be a conveyor for drying. The pellets contain ammonium phosphate and polyhalite. It has been found that a retention time of around 3 minutes in a drier 14 capable of heating the pellets to a temperature of around 150° C. is sufficient to adequately dry the pellets. This can harden them. Pellets manufactured using polyhalite powder, phosphoric acid and ammonia can have a crush strength in the region of 2.2 kgf. This compares well with a generally accepted lower limit of 2.2 kgf for acceptable agricultural pellets. Moisture can be extracted from the dryer using a reverse jet air filter. The operating temperature and retention time in the dryer can be selected to provide pellets of the desired strength for subsequent handling. A rotary drier may be used to dry the pellets.

The dried material expelled from the drier 14 can be screened to separate undersize and/or oversized pellets from pellets of a desired size range. The desired size range may, for example, be that which passes a 4 mm screen but does not pass a 2 mm screen. Alternatively, other sizes may be chosen as appropriate to the desired application.

The dried pellets may be passed through a first size screener 12 to separate oversized pellets from pellets having a desired upper size. The oversized pellets are reground. This may be suitably be done using high pressure grinding roller (HPGR) equipment 16, or in a ball mill (e.g. a continuous “Hardinge” ball mill) or an attritor mill. The reground pellets are supplied to the second hopper 5 to be recycled through the process again. The dried pellets may be passed through a second size screener 13 to separate undersize pellets from pellets having a desired lower size. The undersized pellets are supplied back to the second hopper 5 to be reintroduced to the granulator 6 to be recycled through the process again.

Finally, the in-size pellets (as shown by arrow 17) can be cooled and packaged 15, for example in 600 kg bags or 25 kg sacks, or shipped loose for use or further processing elsewhere. The pellets can be supplied for agricultural use. Eventually they can be spread on a field or other agricultural or horticultural substrate to act as a fertiliser. The composite pellets may be used for purposes other than fertilisation.

Other additives may be included in the pellets. Such additives may one or more of the following, in any combination:
a component having the effect of chemically and/or mechanically stabilising and/or preserving the pellets: for example to increase their shelf life, reduce their susceptibility to environmental contaminants or to reduce the likelihood of them being broken up during spreading (e.g. a pH buffer);
a component having the effect of enhancing the fertilising effect of the polyhalite and/or the ammonium phosphate: for example by accelerating or retarding the breakdown of the polyhalite in the field;
a component having the effect of protecting or enhancing the growth of crops by means other than fertilising: for example a herbicide, fungicide, insecticide, rodenticide, hormone, plant stimulant or mycorrhizal fungus or spore;
a seed: which may be a seed of an angiosperm, gymnosperm and/or of a crop species (e.g. a cereal such as wheat, maize, rice, millet, barley, oats or rye);
a further fertiliser composition providing macro or micronutrients in addition to the polyhalite and ammonium phosphate;
a pigment;
a component having the effect of altering soil pH: for example lime or sulphur.

Such a component may be added at any suitable stage in the process. For example it could be combined with the polyhalite powder prior to or during a granulation stage as described above, or with the polyhalite/phosphoric acid/ammonia mix, or with the phosphoric acid/ammonia mix, or it could be sprayed or otherwise coated on to the pellets before or after drying.

The composite pellets are preferably substantially free from voids, for example having not more than 1%, 2% or 5% by volume of air.

Where a property is specified above in respect of a single pellet, that criterion may be applied in the case of a bulk pelletised fertiliser as (i) the mean value over the bulk, (ii) the median value over the bulk, or (iii) by more than 50% or more than 80% of the pellets of the bulk fertiliser having the requisite property.

In three examples, a DAP preneutraliser slurry was created by mixing phosphoric acid and ammonia gas to a pH of 5-6. Polyhalite powder was weighed and added to a granulation mixer. The polyhalite powder was mixed in the granulation mixer and the slurry was added to the polyhalite powder by pouring. Ammonia gas was then injected into the mixture. Once the slurry powder mixture reached a pH of about 7, heat was applied to the mixture to dry it and begin granulation. Granules were formed and screened using a Tyler 5-9 sieve to screen out granules that were the desired 2-4 mm particle size.

In the first example, 3.36 kg of phosphoric acid was added to the preneutraliser and mixed whilst ammonia gas was bubbled in until the pH reached about 6. 1550 mL of water was added throughout the process to assist the mixture passing through an insoluble stage when the mixture went through the pH range of 1.6 to pH 5. 1 kg of polyhalite was added to the granulation mixer and the slurry introduced. Ammonia gas was bubbled in until the pH reached about 7 and then the mixture was granulated to produce pellets. The resultant pellets were screened to a desired 2-4 mm particle size. The resultant pellets had a hardness of 2.3 kgf. The resultant pellets had a 80% DAP to 20% polyhalite powder by weight ratio.

In the second example, 2.73 kg of phosphoric acid was added to the preneutraliser and mixed whilst ammonia gas was bubbled in until the pH reached about 6. 1250 mL of water was added throughout the process to assist the mixture passing through an insoluble stage when the mixture went through the pH range of 1.6 to pH 5. 1.75 kg of polyhalite was added to the granulation mixer and the slurry introduced. Ammonia gas was bubbled in until the pH reached about 7 and then the mixture was granulated to produce pellets. The resultant pellets were screened to a desired 2-4 mm particle size. The resultant pellets had a hardness of 2.1 kgf. The resultant pellets had a 65% DAP to 35% polyhalite powder by weight ratio.

In the third example, 1.68 kg of phosphoric acid was added to the preneutraliser and mixed whilst ammonia gas was bubbled in until the pH reached about 6. 1000 mL of water was added throughout the process to assist the mixture passing through an insoluble stage when the mixture went through the pH range of 1.6 to pH 5. 3 kg of polyhalite was added to the granulation mixer and the slurry introduced. Ammonia gas was bubbled in until the pH reached about 7 and then the mixture was granulated to produce pellets. The resultant pellets were screened to a desired 2-4 mm particle size. The resultant pellets had a hardness of 2.1 kgf. The resultant pellets had a 40% DAP to 60% polyhalite powder by weight ratio.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A method for forming a pelletised fertiliser product, the method comprising:
forming a first mixture of phosphoric acid and ammonia;
adding the first mixture and polyhalite powder to a granulator to form a second mixture; and
supplying ammonia to the second mixture to complete formation of ammonium phosphate within the second mixture whilst the granulator is processing the second mixture to form pellets.

2. The method according to claim 1, wherein the granulator processes the second mixture to form pellets by mixing the second mixture whilst ammonia is supplied.

3. The method according to claim 1, wherein forming a first mixture of phosphoric acid and ammonia comprises mixing the phosphoric acid whilst introducing ammonia to the phosphoric acid.

4. The method according to claim 1, wherein the ammonia present in the first mixture reacts with the phosphoric acid to form ammonium phosphate, and the ammonia is introduced in an amount that is insufficient to complete formation of ammonium phosphate within the first mixture.

5. The method according to claim 1, wherein supplying ammonia to the second mixture comprises introducing ammonia gas to the second mixture.

6. The method according to claim 1, wherein supplying ammonia to the second mixture comprises introducing liquid ammonia to the second mixture.

7. The method according to claim 1, wherein the ammonia present in the second mixture reacts with the phosphoric acid to form ammonium phosphate, and the ammonia is introduced in an amount that is sufficient to complete formation of ammonium phosphate within the second mixture.

8. The method according to claim 1, wherein a predetermined ratio of ammonia to phosphoric acid completes formation of ammonium phosphate from phosphoric acid, and an amount of ammonia is introduced to the first mixture at less than the predetermined ratio.

9. The method according to claim 1, wherein a predetermined ratio of ammonia to phosphoric acid completes formation of ammonium phosphate from phosphoric acid, and the ammonia is introduced to the second mixture to substantially meet the predetermined ratio.

10. The method according to claim 1, wherein forming a first mixture of phosphoric add and ammonia comprises adding a liquid to the first mixture.

11. The method according to claim 10, wherein the liquid is water.

12. The method according to claim 10 wherein the liquid is ammonia.

13. The method according to claim 1, wherein the powder has a mass average grain size in the range from 50 μm to 500 μm.

14. The method according to claim 1, wherein the pellets comprise more than 80% by weight of the mixture of polyhalite powder and ammonium phosphate.

15. The method according to claim 1, wherein an amount of first mixture is added to the polyhalite powder so that the pellets comprise between 20% and 80% of ammonium phosphate by weight.

16. The method according to claim 1, wherein an amount of first mixture is added to the polyhalite powder so that the pellets comprise between 20% and 80% of polyhalite powder by weight.

17. A fertiliser pellet principally composed of a mixture of polyhalite powder and ammonium phosphate.

18. The fertiliser pellet according to claim 17, wherein the pellet comprises between 60% and 80% of ammonium phosphate by weight.

19. The fertiliser pellet according to claim 17, wherein the pellet comprises between 20% and 40% of polyhalite powder by weight.

20. (canceled)

21. A fertiliser product comprising a plurality of pellets as claimed in claim 17.

22. (canceled)
